(19) United States
(12) Patent Application Publication
(10) Pub. No.: US 2006/0099399 A1
(43) Pub. Date: May 11, 2006

(54) Flexible facing of sandstone and method for manufacturing flexible facing of sandstone

(76) Inventor: Tomasz Kras, Krakow (PL)

Correspondence Address: Mr. Miroslaw Paczuski, Patrade Int'l, P.O. Box 76, Center Valley, Central Valley, PA, 18034, US

(21) Appl. No.: 11/103,220

(22) Filed: Apr. 12, 2005

(30) Foreign Application Priority Data
Nov. 9, 2004 (PL) P-371110

(51) Int. Cl. B32B 3/00

(52) U.S. Cl. 428/312.2; 428/312.6; 264/36.1

(57) ABSTRACT

A flexible face-slab has a layer (11) of natural sandstone from which its natural binding material has at least been partially removed, but without disturbing its natural granular structure consisting of sand-grains being in contact with each other. The empty spaces, created in the layer (11) after the removal of the natural binding material are partially or completely filled with a flexible binding agent, which can be a synthetic resin-based binder. One side of the layer (11) of natural sandstone is strengthened by a base layer (12) that acts as a stabilizing layer. This may incorporate a mesh (13), woven cloth material, or threads of natural or an artificial material. The total thickness (17) of the sandstone layer (11) and the base layer (12) after completion of the manufacturing process may range between 2 and 6 mm.

### CROSS-REFERENCE TO RELATED APPLICATIONS

This application claims priority to Polish Patent Application No. P-371110, filed Nov. 9, 2004, the contents of which are incorporated herein by reference.

### BACKGROUND OF THE INVENTION

1. Field of the Invention

The present invention relates to a flexible facing of sandstone and a method for manufacturing the flexible facing of sandstone.

2. Brief Description of the Background of the Invention Including Prior Art

Since the earliest times, sandstone, i.e. sand grains held together in a natural matrix, have been successfully used as a building material. Many ancient structures and historical buildings made of this locally available feasible and easily worked material have survived until present times. Sandstone gives a pleasant and ‘soft’ visual effect. Here and there on its surface may be seen local patches of different color or lines of different color stretching along vague lines; this specific coloration makes sandstone even more attractive. However, sandstone has its disadvantages as a building material, the main ones being rigidity, friability, and high density.

EP Patent No. EP 05 64 760 A1, details of which are referred to herein, describes an impregnation method and an epoxy-resin based impregnating agent. The agent is applied to mineral materials to be used to construct facades and to concrete surfaces, as well as to impregnate natural stone, for example sandstone.

U.S. Pat. No. 4,664,955, details of which are referred to herein, describes a composite plate to be used as a building material to cover walls and ceilings. The plate consists of a thin polymer film with metal foils glued to its two external planar surfaces. Next, a plate of natural sandstone is glued to one of the two foil-covered surfaces. The disadvantage of this particular arrangement is its rigidity and hence the difficulty in changing its shape.

U.S. Pat. No. 6,032,488 describes a material manufactured in the following manner: two materials, e.g. sandstone and powdered Pyrex® glass, each having different porosity, are placed together and heated in special thermal cycles.

U.S. Pat. No. 6,068,893 describes small plates made of natural sandstone. The plates are cut to the required size and heated to a temperature ranging between 1200° F. and 1800° F. They are then glazed, and reheated to a temperature between 1800° F. and 2500° F.

Also, a thin-walled plate of sandstone is known, as described in a publication No. WO 00/30848 of International Patent Application. This plate is affixed to a highly strong ceramic plate.

Furthermore, another slab-preparation of natural sandstone is known, such as the one described in the publication of International Patent Application No. WO 02/064903. The patent specification describes this plate as consisting of a natural sandstone layer glued to a reinforced layer using a special adhesive agent.

### SUMMARY OF THE INVENTION

### PURPOSES OF THE INVENTION

It is an object of the present invention to provide a finishing material that has the attraction of natural sandstone yet is flexible and relatively light.

It is another object of this invention to provide a method for manufacturing flexible finishing material with the superficial features of natural sandstone, in particular with its characteristic natural structure, and to retain and expose the inherent colors and the natural vein-patterns of natural sandstone.

These and other objects and advantages of the present invention will become apparent from the detailed description, which follows.

### BRIEF DESCRIPTION OF THE INVENTION

The method for manufacturing a flexible facing based on natural sandstone as described in this invention consists in the concept that the natural matrix that binds sand particles and grains is at least partially removed from the sandstone, and a flexible, natural or synthetic binding agent is introduced into the empty spaces left.

Under the method as described in this invention, it is possible to treat chemically the natural sandstone material while the natural binder is being removed; the chemical treatment involves the chemical removal of the natural binder or binding agent using an aqueous solution of hydrofluoric acid (HF). During this process, the natural sandstone structure, composed of sand particles adjacent contact, remains in its original state.

While removing the natural binder/matrix, it is possible to kiln the sandstone at temperatures ranging between 750° C. and 1200° C. for a period of ten to twenty hours at maximum; the sandstone is heated under a controlled temperature rise of between 80 C° to 150 C° per hour. After the heat-treatment has been completed, the sandstone is sprayed with water and/or an aqueous solution of hydrofluoric acid, or with other liquids.

Between the completed heat-treatment and prior to spraying with water, the sandstone should be placed in a stabilizing unit.

As soon as the flexible binding agent is introduced to the sandstone, the sandstone is preferably consolidated by putting a stabilizing material on one of the sandstone's planar surfaces. It is recommended that this stabilizing material should be combined with some liquid flexible agents or they may be poured over the base material. During the saturation or pouring, liquid flexative agents are ideally to be poured over the stabilizing material/strengthening agents. The next stage is to slice off a sandstone layer of predetermined thickness.

In the ideal situation one planar face of the sandstone has been coated with impregnating and/or protective agents.

As soon as the stabilizing material is introduced to the sandstone, both the stabilizing material and the cut-off sandstone layer may be rendered plastic by rolling and simultaneous heating of the lamina, i.e. a cut-off, thin layer.

Additionally, the basic concept of this invention requires that the flexible facing of natural sandstone has a natural sandstone core, consisting of sand grains held together by a flexible binding agent or matrix that fills the empty spaces created after the removal of the natural binding materials originally contained in the sandstone.

Sand grains contained in the natural sandstone matrix can retain the original and unchanged structure of the natural sandstone.

The flexible binding agent should preferably be a resin material or a material containing acrylic compounds.

The natural sandstone matrix and the binding agent can develop into a specific layer This layer is strengthened by a flexible film with a stabilizing material, and/or on one surface of this layer, there is a special protecting and/or impregnating film.

The protecting and/or impregnating film can be made of a dyed, transparent, semitransparent, and/or with a matt finish.

### BRIEF DESCRIPTION OF THE DRAWINGS

In the accompanying drawings one of the possible embodiments of the present invention is shown, where:

FIG. 1 shows a cross-section of a flexible facing of sandstone;

FIG. 2 shows a cross-section of the flexible facing of sandstone joined with a light filling material;

FIG. 3 shows an enlarged structure of the flexible facing of sandstone;

FIGS. 4A and FIG. 4B schematically illustrate a process for manufacturing the flexible facing of sandstone.

### DESCRIPTION OF INVENTION AND PREFERRED EMBODIMENT

The particulars shown herein are examples and are intended to elucidate the various possibilities of the presented invention only. They are provided in to provide what is believed to be the most useful and easily understood description of the principles and conceptual aspects of the invention. Therefore, no attempt has been made to show details of the invention in more detail than is necessary for it being understood at a fundamental level. The description and the drawings should make it apparent to interested parties how the various forms of the invention may be used in practice.

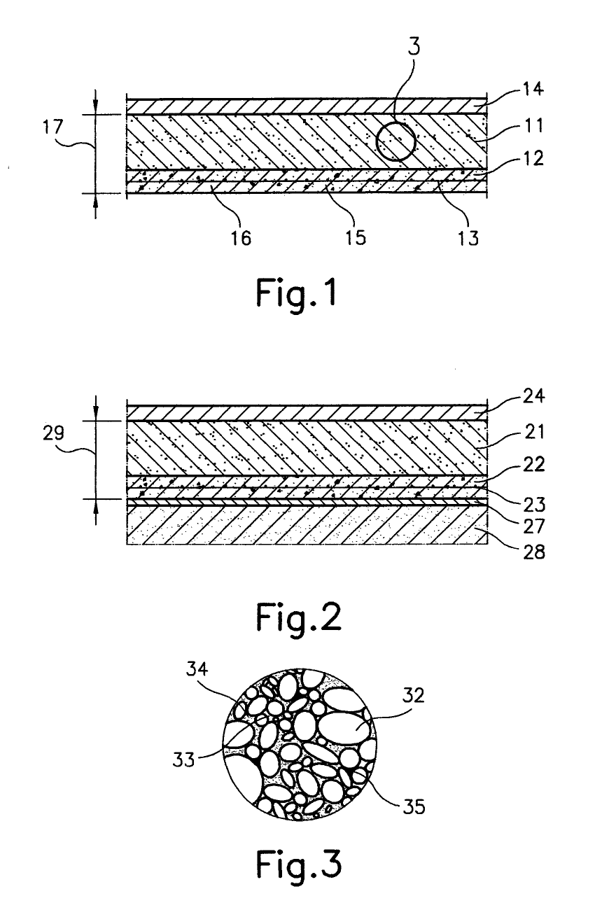

Referring to FIG. 1, the flexible facing consists of one layer 11 of natural sandstone with natural binders or binding materials at least partially replaced by flexible binding materials, and a sandstone structure left. This structure consists of sand particles and/or sand grains in contact with each other. The sand grains in natural sandstone so treated retain the untouched/undamaged structure of the original material and even if they are displaced slightly towards each other, owing to minimal grain redistribution, the natural patterns and colors remain. In the layer 11, the spaces created after the removal of the natural binders are partially or fully filled with flexible binding materials, typically synthetic resin binders, e.g. acrylic resin ‘Osakryl’. One face of the natural sandstone layer 11 is strengthened by a base layer 12 that is a stabilizing layer or a stabilizing material, e.g. acrylic. In this stabilizing layer, there are set of a mesh 13, cloth or threads of glass fiber, natural material or any other artificial material. After the processing procedure accomplished, the sandstone layer 11 and the base layer 12 have both a total thickness 17 of 2 mm to 6 mm. The base layer 12 may contain various solid inclusions 15 or micropores filled with air or gas of a particular type. The top layer 14 is a protective or finishing layer. It may be made of any material that suits the intended site of application of the facing. The top layer 14 may also be produced after the impregnation agent has set. To make the appearance of the facing as close to natural sandstone as possible, it is recommended that the top layer 14 consist of a transparent, semitransparent or matt finish, for example a polymerized silicone, an oil-based solution of Teflon, or acrylic resins.

Referring to FIG. 2, in which a flexible facing is depicted, this flexible facing is glued to a stable structural element consisting of a layer 21 of natural sandstone, a top layer 24, a base layer 22, which is reinforced with threads, mesh or cloth 23. After the processing procedure accomplished, the total thickness 29 of the natural sandstone layer 21 and the base layer 22 together ranges from 2 mm to 6 mm. The flexible facing is fixed on a plate using mortar 27, for example a concrete plate 28, or on brickwork, or on any other element coated with an interfacing layer of plaster, gypsum board, or any other similar material usually applied in the construction industry.

Referring to FIG. 3, in which an enlarged structure of the flexible facing is shown, this structure of the flexible facing is based on a natural sandstone structure. The sandstone is in its original condition and consists of sand grains 32 in contact with each other and embedded in a flexible matrix, such as an acrylic resin 34, this flexible material being poured over the granular sand structure. It may happen that some of the sand grains are still partially held together by their natural binder 35 that was not totally removed during the treatment process. It is also possible that among the sandstones grains, some empty spaces 33 may be present because they have not been completely filled with flexible material after the removal of the natural binding agent.

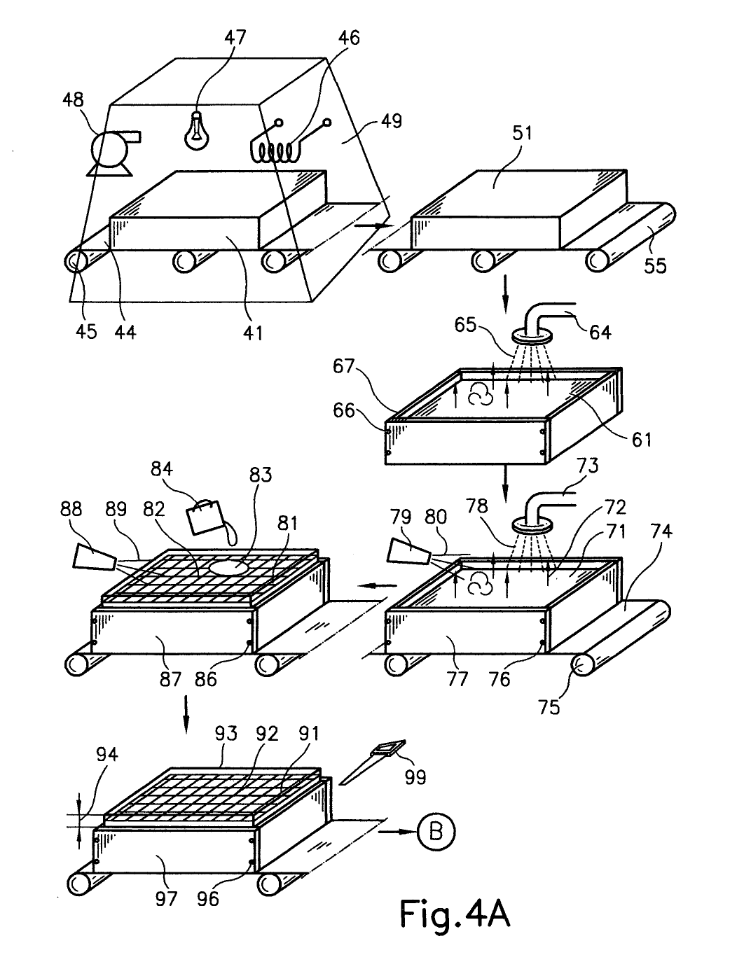

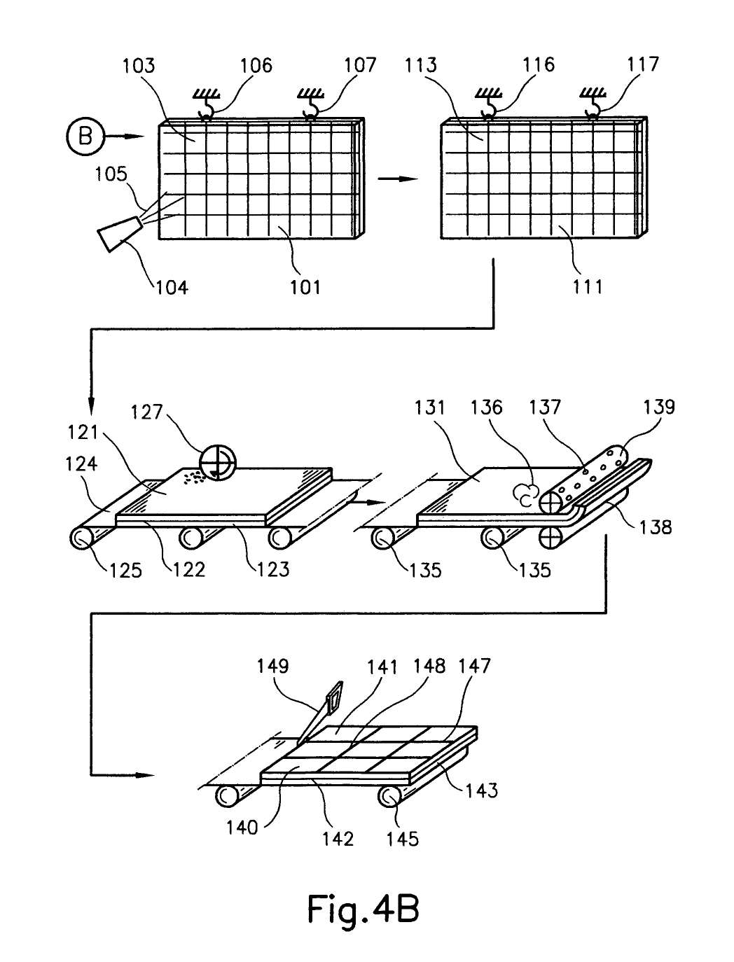

Referring to FIGS. 4A and 4B, the first process of manufacturing a facing panel of natural sandstone, is to produce a prefabricated sandstone element. The dimensions of such an element depend on the intended use of the facing. A prefabricated sandstone element 41 of predetermined dimensions is pre-dried, possibly in the open air, and is then placed in a furnace 49. Heat may be supplied by electric heaters 46, a flood-light and heating unit 47, or a fuel-burner 48. Next, conveyors fitted with drive systems 45 transport the prefabricated sandstone element 41 into the furnace 49. Here it is kilned at a temperature between 750° C. and 1200° C. for ten to fifteen hours. The prefabricated sandstone element 41 is heated gradually with a controlled rate of temperature increase between 80 C° to 150 C° per hour. During the kilning process in the furnace 49, and also after it, there is a possibility to introduce to the furnace 49, air, steam, another gas or substances that will react with the natural sandstone matrix.

Upon the completion of the kilning process, the semi-finished product 51 has been created from a natural block of sandstone. The product 51 contains unchanged natural sandstone. From this mineral substance, the natural bonding agents have been largely or even completely removed. The product 51 is removed from the furnace on a conveyor 49 equipped with a drive system 55 or by other means and is then placed in a stabilizing unit.

The semi-finished product 61 is placed in the stabilizing unit 67. This is equipped with a special system 66 that brings a controlled pressure onto selected faces of the semi-finished product 61. The semi-finished product 61, which is still hot, is next exposed to thermal shock. This may be provided in several ways, such as a cold water shower 65, the cold water being supplied through sprinklers 64, as an aqueous solution of hydrofluoric acid (HF), or with any other liquid. The type of sandstone is the deciding factor as to which liquid will be used to produce the thermal shock The object of this process applied to the semi-finished product 61 is firstly to create a specific concentration of the gases contained in the water vapor produced and permeating the entire mass of the semi-finished product 61, secondary to continue the leaching-out of the natural binders, some of which may still be present among the sand particles, and thirdly for weakening the intermolecular bonds among sand grains without displacing them.

Another variation to the process of manufacturing flexible facings from natural sandstone exists. In this option, the sandstone can be chemically treated without being heated. It is possible to leach out the natural binders and other cohesive materials present in sandstone using a hydrofluoric acid (HF) solution. During this process the natural sandstone matrix consisting of sand particles in contact with each other remains in its original structural state. During the chemical treatment process, the semi-finished product may be sprayed with water or with another liquid using spraying or pouring units. The semi-finished product can also be treated with steam supplied through a unit fitted with nozzles.

The semi-finished product 71, cooled down as described above, shows novel strength properties. It is next placed in the stabilizing unit 77 as described earlier and here it is saturated with a diluted liquid material, for example with a resin agent 78, using a sprayer unit 73. The diluted liquid resin material may contain dyes to provide different colors as required; this diluted liquid material is also capable of permeating the thickness of the facing so as to give it a specific coloration. Simultaneously, both the semi-finished product and the liquid material 71 contained in it are intensively dried using a blower unit 79. Damage to the semi-finished product 71 during its transportation and/or during further production processes is obviated by the following equipment—the stabilizing unit 77, the compression system and/or a stretching system 76. These systems are set to exert forces at a predetermined level on pre-selected areas of the semi-finished product 71. The stabilizing unit 77 can be mounted on a conveyor 74 equipped with a drive system 75.

As soon as the resin material has set, the semi-finished product 81 is placed on the stabilizing unit 87 and overhangs its edges by a distance equaling the design thickness 85 of the facing being produced. In this case, the stabilizing unit 87 may take the form of a mold equipped with special pull-rods 86. Such a mold must be adjusted to the shape of the semi-finished product 81. Next, stabilizing material 82 is introduced to the semi-finished product 81. The stabilizing material 82 is saturated with flexible materials in liquid form 83, or they are poured over it. They may be resins, for example acrylic compounds. The feeders 84 distribute the flexible materials 83 which are poured over the stabilizing material 83 or over the reinforcing materials 82, typically threads, mesh, or synthetic cloth, for example, fiberglass. The threads, mesh, or cloth 82 can also be made from natural materials. During this phase, the stabilizing material 82 is intensely dried 89 using a blower unit 88. As soon as the semi-finished product 81 has become saturated and the product, still in the stabilizing unit 97 with pull-rods 96, has been successfully reinforced with a layer of flexible material 93, for example resins, and with stabilizing material 92, it is cut into thin-walled facings of predetermined thickness 94. The cutting procedure is performed using cutters 99 such as circular saws or band saws or steel wires. After the removal of the facing slice, a new section of the stabilizing material is placed in the stabilizing unit 97, and resin material is poured over it. Next, it is dried by blowing, and the next slice is cut off from the semi-finished product. This cycle is repeated until the whole semi-finished mass has been used.

The face-slabs 101, 111, which have been strengthened with a stabilizing layer 103, 113 respectively, can be hung on special racks 106, 107, 116, 117 and, then, having been allowed to season for a predetermined period may be further treated.

After seasoning, the face-slabs 121 are placed on conveyors 124 fitted with drive systems 125 with their stabilized faces 123 lying on the conveyor; their natural sandstone upper face is then, mechanically treated, i.e. either grinded or polished or otherwise abraded or machined 127. In addition, the possibility exists to chemically treat the face-slabs 121 using impregnating or protective agents. The substances applied are related to the intended final placement of the product.

While being carried on the conveyors 135, the natural sandstone flexible facings 131 can be plasticized by steam rolling, and this would constitute the final phase of the manufacturing process as described in this invention. The rolling mill 138 consists of two rollers. Steam must be supplied and is delivered through holes 137 either from both rollers, from an upper roller 139 only, or from a lower roller. The steam heats the face-slab to a temperature at which the resin component becomes plasticized. If the planned application of the face-slab requires it, a rolling process may be applied to totally and finally destroy the remains of the rigid bonds existing among sand grains and particles.

The thin-walled flexible facing 141, which is laid out on the conveyors 145 with its stabilizing material side 143 face-down on the conveyor, can be either cut into plates 140 of predetermined size by appropriate tools or cutting equipment 149, or used as whole units to cover surfaces that have been properly pre-treated and prepared. Using face-slabs of natural stone, joined together, it is possible to construct monolithic walls or large-sized elements and to replicate desired shapes and forms, e.g. the shapes of sandstone boulders. Unlike their natural equivalents, however these are very light in weight. The thickness of the top layer of the artificial boulder facing varies between 3 and 7 mm. Thanks to acrylic resins contained in the facings, individual thin-walled face-slabs can be seamlessly joined together by seam-welding at a temperature not exceeding 200° C. Empty gaps between individual adjacent face-slabs can be filled with sand grains, and single sand grains can be rammed closely together. In this way, an entire surface area faced with natural sandstone face-slabs can be creatively, even artistically, and precisely designed and arranged. The flexible facings, based on natural sandstone, constitute a building material that unites the qualities of a flexible ceramic plate, has the advantages of a wallpaper, and displays the properties of large-sized elements imitating natural stone. The attractive appearance owes its unique and very decorative texture to the patterns developed by nature millions of years ago.

The preferred embodiment having been thus described, it will now be evident to those skilled in the art that further variation thereto may be contemplated. Such variations are not regarded as a departure from the invention, the true scope of the invention being set forth in the claims appended hereto.

What is claimed is:

1. A method for manufacturing a flexible facing of sandstone comprising the following steps:
forming a prefabricated sandstone element from natural sandstone;
removing at least partially natural binding materials binding sand particles and grains from the prefabricated sandstone element remaining undamaged structure of the prefabricated sandstone element consisting of sand particles and grains;
filling empty spaces in the prefabricated sandstone element left after the removing of the natural binding materials with a flexible natural or synthetic binding material; and
forming thin-walled facings of sandstone from the prefabricated sandstone element.

2. The method for manufacturing the flexible facing of sandstone according to claim 1 wherein the removing at least partially the natural binding materials binding sand particles and grains from the prefabricated sandstone element is done by chemically treating the prefabricated sandstone element using an aqueous solution of hydrofluoric acid (HF).

3. The method for manufacturing the flexible facing of sandstone according to claim 1 wherein the removing at least partially the natural binding materials binding sand particles and grains from the prefabricated sandstone element is done by heating the prefabricated sandstone element under a controlled temperature rise of between 80 C° to 150 C° per hour, kilning the prefabricated sandstone element at temperatures ranging between 750° C. and 1200° C. for a period of ten to twenty hours and spraying the prefabricated sandstone element with water and/or an aqueous solution of hydrofluoric acid (HF) and/or with other liquids.

4. The method for manufacturing the flexible facing of sandstone according to claim 1 wherein the prefabricated sandstone element is placed in a stabilizing unit after the forming the prefabricated sandstone element from natural sandstone.

5. The method for manufacturing the flexible facing of sandstone according to claim 1 wherein the prefabricated sandstone element is consolidated by putting a stabilizing material on one surface of the prefabricated sandstone element after the filling empty spaces with the flexible natural or synthetic binding material, pouring liquid flexative agents over the stabilizing material and cutting the prefabricated sandstone element into thin-walled facings of predetermined thickness.

6. The method for manufacturing the flexible facing of sandstone according to claim 5 wherein each of the thin-walled facings is coated with impregnating and/or protective agents after setting apart from the prefabricated sandstone element.

7. The method for manufacturing the flexible facing of sandstone according to claim 5 wherein the thin-walled facings are rendered plastic by rolling and simultaneous heating.

8. A flexible facing of sandstone comprising
a natural sandstone core consisting of sand particles and grains bonded together by flexible binding materials filling empty spaces left after removing of a natural binding material originally contained in sandstone wherein the particles and sand grains are not displaced within an original structure of sandstone as it developed naturally over geological time.

9. The flexible facing of sandstone according to claim 8 wherein the flexible binding materials form a matrix filling empty spaces left after removal of the natural binding material originally contained in the sandstone.

10. The flexible facing of sandstone according to claim 9 wherein particles and sand grains contained in the matrix retains an original and unchanged structure of the sandstone.

11. The flexible facing of sandstone according to claim 8 wherein the flexible binding materials are a resin material and/or a material containing acrylic compounds.

12. The flexible facing of sandstone according to claim 8 wherein the natural sandstone core and flexible binding materials has a shape of a thin-walled facing strengthened by a flexible film with a stabilizing material.

13. The flexible facing of sandstone according to claim 12 wherein the thin-walled facing on one surface has a special protecting and/or impregnating film.

14. The flexible facing of sandstone according to claim 8 wherein the special protecting and/or impregnating film has a dyed and/or a transparent and/or a semitransparent and/or a matt finish.
